(19) United States
(12) Patent Application Publication
(10) Pub. No.: US 2008/0308686 A1
(43) Pub. Date: Dec. 18, 2008

(54) Connecting Part and Set of Orientable Connecting Parts

(75) Inventors: Roland Boltz, Estrees-Saint-Denis (FR); Stephane Quertelet, Remy (FR)

Correspondence Address: YOUNG & THOMPSON, 209 Madison Street, Suite 500, ALEXANDRIA, VA, 22314, US

(73) Assignee: I.C.M. GROUP, Montbard (FR)

(21) Appl. No.: 11/914,603

(22) PCT Filed: May 19, 2006
(86) PCT No.: PCT/FR2006/001139

§ 371 Date: May 9, 2008

(30) Foreign Application Priority Data
May 20, 2005 (FR) 0505052

(51) Int. Cl. F16L 3/00; F16M 13/00

(52) U.S. Cl. 248/62; 248/124.1

(57) ABSTRACT

A connecting part includes a base (2) fixable to a support and to a perforated plate (4) for fixing a structure or another connecting part. The plate (4) includes a first perforation and at least one second perforation (12) in the form of a longitudinal optionally curved hole, which is oriented in such a way that it is substantially inclined with respect to the tangent of a circle whose center is the point of the first perforation and which passes by the point of the second perforation (12).

The present invention concerns a connecting part such as a head plate, for example, and a set of orientable connecting parts.

Connecting parts can be used for fixing or supporting all types of structures. A connecting part, sometimes also called a head plate, conventionally includes a flat base and a plate oriented perpendicularly to the base. A first connecting part is fixed to a support, for example a wall, a ceiling, a beam, etc. by means of its base and a second connecting part is fixed, also by its base, to one end of a structure to be fixed or supported. The plates of the two connecting parts are then placed one against the other and bolted together. Of course, holes are provided on the one hand in each connecting part base for fixing them to the structure or the corresponding support and on the other hand in the plates for fastening them together.

Such connecting parts have varied application fields. They can be used whenever it is a question of fixing a structure to a support, in particular if the support and the structure have surfaces inclined relative to each other (without being at right angles). One non-limiting example of use is the fixing of metal structures intended to support cable trays. Such structures are sometimes fixed to ceilings or beams and the use of orientable connecting parts enables vertical uprights to be fixed to an inclined ceiling, for example.

It is beneficial for the same pair of connecting parts to be used for assemblies with different inclinations between the supported part and the support. Known connecting parts able to adapt to more than one inclination are generally of two types. In a first type, various angles are predetermined and the plates of the connecting parts include a number of holes, each hole corresponding to one predetermined angular position. In a second type, the plates of the connecting parts include a circular hole for one screw to be passed through and a substantially circular arc shaped oblong hole, the center of the circular arc corresponding to the hole for a screw.

Connecting parts of the first type provide excellent locking of one plate relative to the other but have the drawback of being unable to adapt to all possible inclinations between the support and the supported structure. Connecting parts of the second type can adapt to all possible inclinations between the support and the supported structure but do not achieve good locking of the two connecting parts the one relative to the other. This is because, if a force is applied to the fixed or supported structure, the plates tend to pivot one relative to the other, this movement being guided by the assembly bolts sliding in the oblong holes.

An object of the present invention is therefore to provide a connecting part that on the one hand adapts to a wide range of possible inclinations between the support and the supported structure and on the other hand guarantees excellent preservation of the relative position of the two connecting parts if a load is applied to the supported structure. The structure of the device is preferably simple and the device preferably has no additional cost compared to prior art connecting parts.

To this end, the present invention proposes a connecting part of the type including on the one hand means for fixing it to a support and on the other hand a perforated plate adapted for fixing a structure or another connecting part.

According to the present invention, the plate includes a first perforation and at least one second perforation taking the form of an oblong hole, possibly curved, the oblong hole being oriented so that its longitudinal axis has, at a given point, a significant inclination relative to the tangent at that point to a circle whose center is the point concerned of the first perforation and that passes through the point concerned of the second perforation.

Thanks to this geometry, when the connecting parts are linked by bolts passing through lined-up perforations in their respective plates and a load is applied, the bolts are pressed against the edges of the second perforation, thereby preventing relative sliding between the two plates. With this geometry, the oblong hole of the second perforation, under load, does not serve as a guide for the corresponding bolt and blocks any movement.

The angle between the tangent to the circle passing through a point of the second perforation and having its center at a point of the first perforation and the longitudinal axis of the oblong hole (or its tangent at the point concerned) is preferably greater than 10°.

In a connecting part according to the invention, the first perforation can be a circular hole intended to receive a bolt. The second perforation can be a rectilinear oblong hole.

If the loads supported are heavy, the first perforation can be a circular hole intended to receive a bolt and the plate can include two rectilinear oblong holes that are inclined, i.e. whose longitudinal axis does not cross the first perforation. The connection between two connecting parts can therefore be made by means of three bolts. In this embodiment, one oblong hole is shorter than the other, for example, and is nearer the first perforation. The two oblong holes are inclined one relative to the other, for example.

In one embodiment of a connecting part according to the invention, the means for fixing it to a support include for example a base extending in a plane substantially perpendicular to the plate. In this embodiment, the base and the plate advantageously consist of sheet metal bent at a right angle. In this way, the connecting part can be produced by cutting and bending.

In this bent embodiment, in a first variant, on the two edges adjacent the bent edge separating the base from the plate, the plate and the base each have a respective rim substantially at a right angle oriented toward the base and the plate, respectively, and the rims of the plate each have at their end near the base a lug bent so as to be introduced into a corresponding slot formed in a rim of the base.

In a second variant, on the two edges adjacent the bent edge separating the base from the plate, the plate and the base each have a respective rim substantially at a right angle oriented toward the base and the plate, respectively, and the rims of the base each have at their end near the plate a lug bent so as to be introduced into a corresponding slot formed in a rim of the plate.

Finally, in a third bent variant, on each of the two edges adjacent the bent edge separating the base from the plate, the plate has a rim substantially at a right angle oriented toward the base, these two rims of the plate extend beyond the plate in the direction of the base and are bent at a right angle so as to rest against the base, and the bent portions of the rims each have at least one perforation corresponding to a perforation in the base intended for fixing it.

Such connecting parts produced by cutting and bending sheet metal are advantageously made from pregalvanized steel.

The present invention also concerns a set of two connecting parts each including a perforated plate, the two perforated plates being disposed one against the other, characterized in that the two connecting parts are connecting parts as described hereinabove. In this set of two connecting parts, the two connecting parts can be identical.

Finally, the present invention also concerns a connecting stirrup including a base intended to be fixed to a support and two parallel perforated branches connected by the base. In a stirrup of this kind according to the invention, each perforated branch takes the form of a plate that includes a first perforation and at least one second perforation taking the form of an oblong hole, possibly curved, the oblong hole being oriented so that its longitudinal axis has, at a given point, a significant inclination relative to the tangent at that point to a circle whose center is a point of the first perforation and that passes through the point concerned of the second perforation.

Details and advantages of the present invention will emerge more clearly from the following description, given with reference to the appended diagrammatic diagrams, in which;

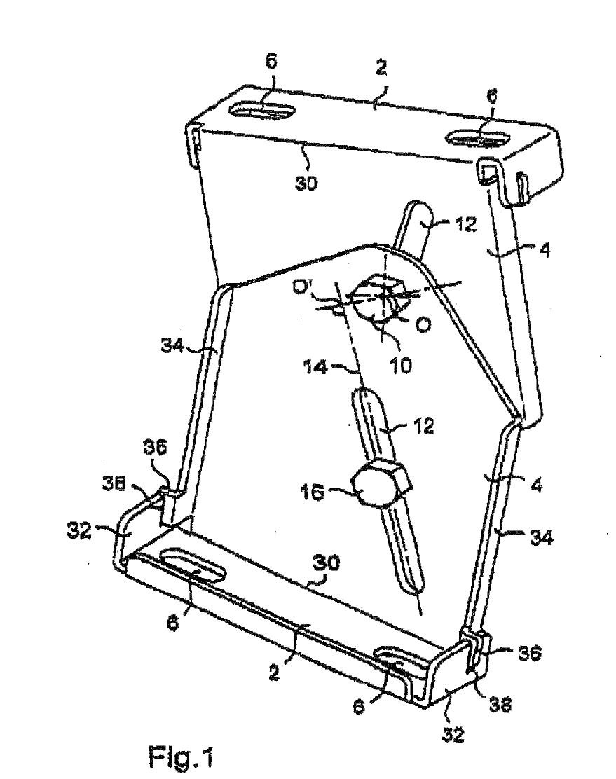

FIG. 1 represents a first embodiment of a set of connecting parts according to the invention,

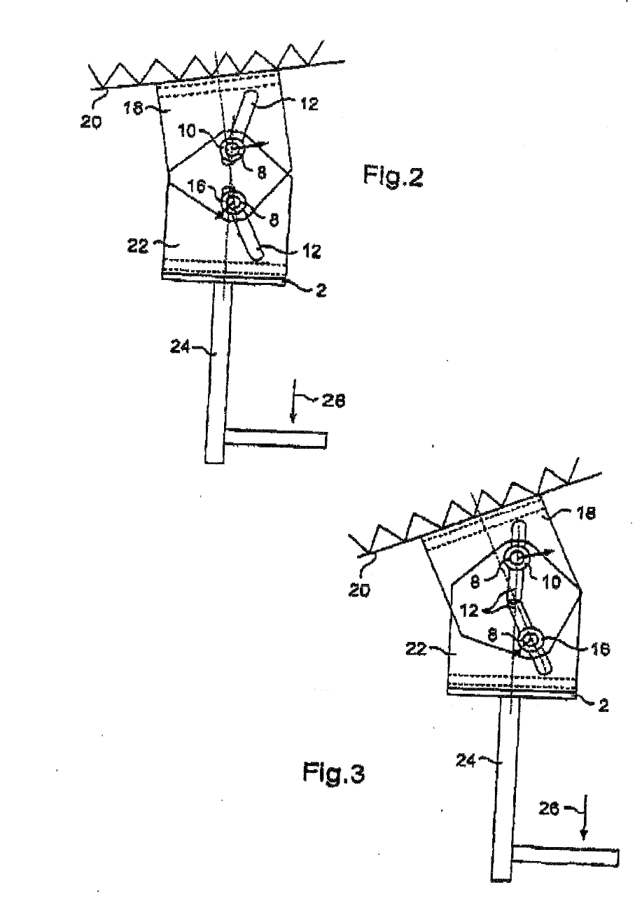

FIG. 2 represents more diagrammatically the set from FIG. 1 used to suspend a structure,

FIG. 3 is a view corresponding to FIG. 2 for another application example,

FIG. 4 shows a second embodiment of a connecting part according to the invention,

FIG. 5 shows a set of two connecting parts according to FIG. 4 assembled together,

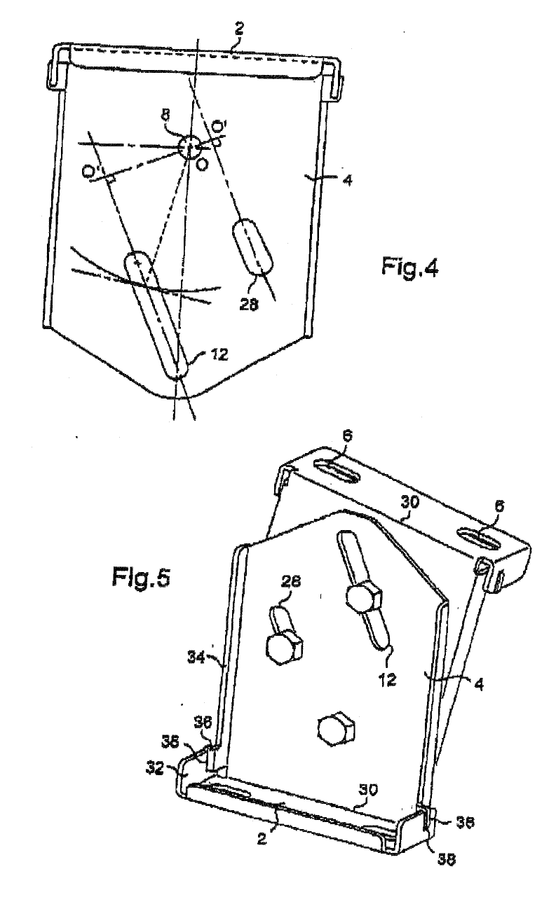

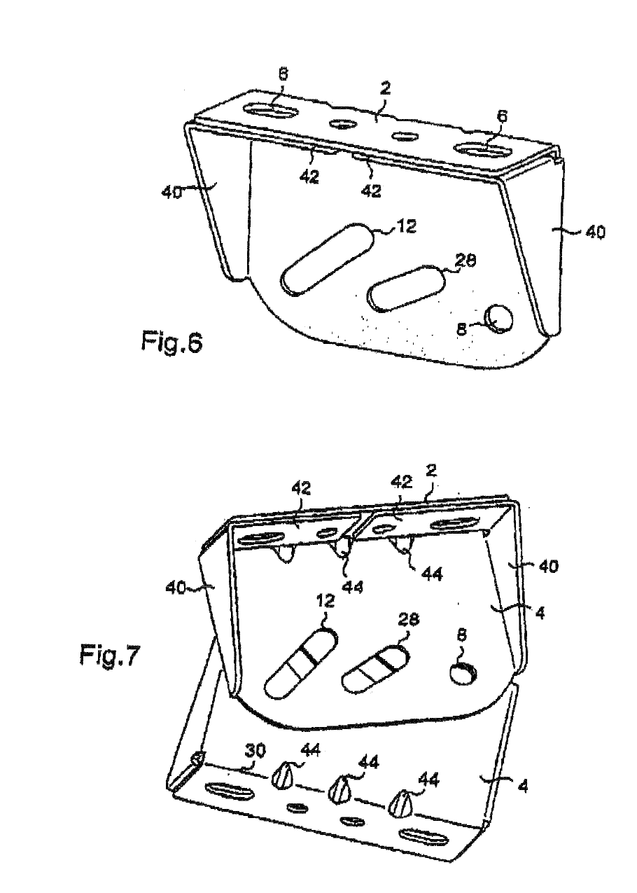

FIG. 6 shows a third embodiment of a connecting part according to the invention, and

FIG. 7 shows a set of two connecting parts according to FIG. 6 assembled together.

In the usual way, a connecting part according to the present invention includes on the one hand a base 2 and on the other hand a plate 4. The base 2 and the plate 4 are perpendicular one relative to the other.

The base 2 takes the form of a relatively narrow strip and includes oblong holes 6 for fixing the connecting part to a support. In the embodiment represented in FIGS. 1 to 3, the base 2 includes two oblong holes at a distance from each other but whose longitudinal axes coincide. Any other configuration of holes for fixing the base 2 to a support can be envisaged here. For example, there could be only circular holes, or one or more circular holes at the same time as one or more oblong holes, and the oblong holes could be oriented differently relative to the oblong holes from FIG. 1.

The plate 4 can be any shape. It has one side corresponding to a longitudinal edge of the base 2. In the FIG. 1 embodiment, the plate 4 has the shape of a square surmounted by a substantially triangular point, the triangular point being opposite the base 2.

The plate 4 includes perforations. In the embodiment of FIGS. 1 to 3 the plate 4 includes firstly a circular hole 8. In FIG. 1, a first bolt 10 passes through the circular hole to make the connection with a second connecting part (and conceals the circular hole). In this first embodiment, the circular hole 8 in the plate 4 is in the triangular part of this plate, i.e. opposite the base 2.

The plate 4 also includes a first rectilinear oblong hole 12 having a major axis 14. This first oblong hole 12 is disposed so that on the one hand the longitudinal axis 14 of this first oblong hole 12 does not cross the circular hole in the plate 4 and on the other hand the orthogonal projection O′ of the center O of the circular hole 8 in the plate 4 onto the longitudinal axis 14 is not in the first oblong hole 12. At any point of the oblong hole 12, the major axis 14 is significantly inclined relative to the tangent at that point to a circle passing through said point and having its center at the circular hole 8.

This particular geometry of the perforations in the plate 4 eliminates or at least reduces very significantly any risk of slippage between two connecting parts mounted back to back as represented in FIG. 1 and assembled together by means of the first bolt 10 passing through the circular hole 8 in a first plate and the first oblong hole 12 in the second plate and a second bolt 16 passing through the first oblong hole 12 in the first plate and the circular hole 8 in the second plate.

FIGS. 2 and 3 show diagrammatically the set of two connecting parts represented in FIG. 1 and explain how they function.

In FIGS. 2 and 3, for reasons of clarity, the first oblong holes 12 of the two connecting parts have been represented in solid line and likewise the circular holes 8. In these two FIGS. 2 and 3, a first connecting part 18 is fixed by its base to a non-horizontal support, such as a ceiling 20, while a second connecting part 22 carries a structure 24 fixed to its base.

Here the two connecting parts are placed back to back as represented in FIG. 1. The faces of the plates of these connecting parts on the side opposite their bases therefore come into contact the one with the other. Note in FIGS. 2 and 3 that the inclination between the structure 24 and the ceiling 20 varies. Continuous adjustment of the relative position of the two connecting parts is obtained by varying the position of the bolts in the first oblong holes 12 of the connecting parts.

If the structure 24 is subjected to a load 26, symbolized by a vertical arrow, a torque is exerted between the two connecting parts 18 and 22 tending to cause these two plates to pivot one relative to the other. The two connecting parts being retained by the bolts 10 and 16, forces are applied to these bolts as represented by the arrows in FIGS. 2 and 3. Note that these forces tend to press the bolts against the walls of the first oblong holes 12 through which the bolts pass. Because of this, no slippage of the bolts in the first oblong holes 12 is possible. The two connecting parts are therefore locked one relative to the other. Note that the greater the load 2G, the stronger this locking.

FIGS. 4 and 5 represent a variant of the connecting parts from FIGS. 1 to 3. The modifications applied here concern only the perforations in the plate 4. Note that this plate includes a circular hole 8, a first oblong hole 12 and a second oblong hole 28. The circular hole 6 is at the same end as the base 2 while the oblong holes 12, 28 are at the same end as the triangular part of the plate 4.

The second oblong hole 28 is substantially parallel to the first oblong hole 12. The above remarks in relation to FIG. 1 are equally valid for each of these oblong holes 12, 28. Accordingly, for each of these oblong holes, the longitudinal axis of the oblong hole does not pass through the circular hole 8. Furthermore, the orthogonal projection of the center of the circular hole 8 onto the longitudinal axes of the oblong holes is not inside the oblong holes. The assembly of the two connecting parts from FIG. 4 is shown in FIG. 5, Note here that three bolts are used. This kind of assembly can be used for heavier loads than the assembly from FIG. 1.

The two connecting parts are locked one relative to the other if a load is applied to one of the connecting parts in exactly the same way as explained hereinabove. This self-locking is obtained because of the geometrical characteristics of the oblong holes 12, 26 and their position relative to the circular hole 8. Considering the circular hole 8 and one of the oblong holes, note that for each point of the oblong hole concerned the tangent to the circle passing through that point and having its center at the center of the circular hole 8 is inclined relative to the longitudinal axis of the corresponding oblong hole. This kind of characteristic could be obtained with curved rather than rectilinear oblong holes.

The manner of producing the connecting parts from FIGS. 1 to 5 is novel. It is quickly seen from this drawing that the connecting parts represented can be produced by bending sheet metal. Connecting parts are more usually produced by welding. The loads to which these connecting parts are subjected are high and a welded construction is then preferred.

In the two embodiments shown in FIGS. 1 to 5, the connecting parts represented have an edge 30 separating the base 2 from the plate 4. This edge 30 corresponds to the common bent edge between the base 2 and the plate 4. The edges of the base 2 adjacent the edge 30 each carry a rim 32 bent at a right angle relative to the base 2 on the same side as the plate 4. Similarly, the edges of the plate 4 adjacent the edge 30 each have a rim 34 bent at a right angle relative to the plate 4 on the side of the plate carrying the base 2. In the embodiments represented in FIGS. 1 to 5, the rims 34 are inside the rims 32.

The rims 32 and 34 are connected together to prevent opening out of the angle formed between the base 2 and the plate 4 at the edge 30. To this end, each rim 34 has at the same end as the base 2 a lug 36 bent outward at a right angle. The rims 32 each have a slot 38 in which one of the lugs 36 is accommodated.

In a variant that is not represented in the appended drawings, a lug could be carried by each of the rims of the base 2 whereas the slots would be on the rims of the plate 4.

Thanks to this novel structure, the plate head can be produced by bending pregalvanized sheet metal (without welding).

FIGS. 6 and 7 show a third embodiment of a connecting part according to the invention.

In this preferred embodiment, note that, compared to the previous two embodiments, the perforations in the plate include, as in the second embodiment, a circular hole, a first oblong hole 12 and a second oblong hole 28. Note also that the connecting part represented in the last two figures is obtained form (pregalvanized) bent sheet metal but the bending is effected differently than for the first two embodiments of the invention.

With regard to the perforations in the plate 4, note that in the second embodiment the circular hole 8 was between the longitudinal axes of the oblong holes 12 and 28. In this third embodiment, the circular hole 8 is on the same side of the two longitudinal axes of the oblong holes. As for the other two embodiments, neither of the longitudinal axes of the oblong holes crosses the circular hole 8 and the orthogonal projection of the center of the circular hole 8 onto the longitudinal axis of an oblong hole is situated outside that oblong hole. There is also an angle between the longitudinal axis of one oblong hole and the tangent to a circle passing through a point of that oblong hole and having its center at the center of the circular hole 8, and this applies to any point of the oblong hole concerned.

The structure of the third embodiment of the connecting part also includes a base 2 and a plate 4 separated by an edge 30. Here the plate 4 has a rim 40 on each of its edges adjoining the edge 30. This rim 40 is extended at the same end as the base 2 beyond the plate 4 and is bent at a right angle to rest against the base 2. The bent portions of the rims 40 form tongues 42. In the embodiment represented, the tongues 42 are on the side of the base 2 facing toward the plate 4. However, these tongues 42 could be on the other side of the base 2. As can be seen, each of these tongues covers substantially half the base 2. They can equally well be shorter and, for example, each cover only one third or one quarter of the base 2. These tongues 42 are then perforated in an arrangement similar to that of the base 2. In the example represented in the drawing the base 2 includes four perforations, two oblong holes and two circular holes. Thus there are an oblong hole and a circular hole in each of the tongues 42, or in the case of shorter tongues only an oblong hole for the embodiment represented, for example. When the connecting part is then fixed to a support (ceiling, structure, etc.), the bolts used for fixing it pass through the tongues 42 and also through the base 2, Tightening these bolts holds the base and the tongues together and therefore stiffens the edge 30. Also to stiffen the edge 30, transverse stiffener ribs 44 are disposed at the edge 30. These ribs 44 are produced by an embossing process, as can be seen in FIG. 7.

FIG. 7 shows two connecting parts like that from FIG. 6 back to back. The connecting bolts between these two connecting parts are not shown. Note that the oblong holes in one plate cross the oblong holes in the opposite plate substantially at right angles.

All the connecting parts described hereinabove reduce slippage between these two connecting parts when they are used in pairs. This therefore increases the solidity of the structure produced with the aid of these connecting parts.

The geometry of the perforations in the connecting parts according to the invention provides self-locking of two connecting parts mounted back to back. As described hereinabove with reference to FIGS. 2 and 3, the higher the load on the connecting parts, the better the interlocking of the two connecting parts mounted back to back.

The parts described enable continuous adjustment of the angular position between the two plate heads mounted back to back. It is possible with connecting parts according to the invention to achieve a continuous variation of the orientation of the plates over a range of 45°.

To mount two connecting parts back to back, it is preferable to use two similar connecting parts. It is not necessary to provide a right-hand plate and a left-hand plate. The same plate can therefore be used for mounting on a support or for mounting on a ceiling.

The embodiments proposed enable the use of standard bolts and it is not necessary with connecting parts according to the invention to protect the threads of the bolts used.

The connecting parts described and represented in the drawings also have the advantage of being produced from cut and bent sheet metal. No welding is needed. However, a welded construction could be envisaged. The cut and bent construction nevertheless achieves significant savings in the cost of production of the connecting parts. These savings can be obtained on the one hand in the method of producing the connecting part and on the other hand in the quantity of material used since the proposed bends mean that the thickness of the sheet metal used can be reduced (see FIGS. 6 and 7)

Another embodiment of a connecting part according to the invention, not shown in the drawings, is stirrup-shaped. It therefore comprises in the standard way a base and two branches. Here the two branches are perforated plates, similar to the plates 4 described hereinabove, disposed parallel and face to face and connected by the base of the stirrup. A stirrup-shaped connecting part like this can be used to fix an angle-iron (U-section or C-section) to an inclined ceiling: the base of the stirrup is then fixed to the ceiling and the perforated flanges of the angle-iron are fixed to the branches of the stirrup. The perforations in the angle-iron then preferably correspond to the perforations in the branches of the stirrup.

The present invention is not limited to the embodiments described hereinabove by way of nonlimiting example. It also concerns variants that will be evident to the person skilled in the art within the scope of the following claims.

1. Connecting part including on the one hand means for fixing it to a support (20) and on the other hand a perforated plate (4) adapted for fixing a structure or another connecting part,
characterized in that the plate (4) includes a first perforation (8) and at least one second perforation (12, 28) taking the form of an oblong hole, possibly curved, the oblong hole (12, 28) being oriented so that its longitudinal axis has, at a given point, a significant inclination relative to the tangent at that point to a circle whose center is a point of the first perforation (8) and that passes through the point concerned of the second perforation (12, 28).

2. Connecting part according to claim 1, characterized in that the first perforation is a circular hole (8) intended to receive a bolt (10. 16).

3. Connecting part according to claim 1, characterized in that the second perforation (12, 28) is a rectilinear oblong hole.

4. Connecting part according to claim 1, characterized in that the first perforation (8) is a circular hole adapted to receive a bolt (10, 16) and in that the plate (4) includes two rectilinear oblong holes (12, 28) that are inclined, i.e. whose longitudinal axis (14) does not cross the first perforation (8).

5. Connecting part according to claim 4, characterized in that one oblong hole is shorter than the other and in that the shorter oblong hole is nearer the first perforation (6).

6. Connecting part according to claim 1, characterized in that the means for fixing it to a support (20) include a base extending in a plane substantially perpendicular to the plate (4).

7. Connecting part according to claim 6, characterized in that the base (2) and the plate (4) consist of sheet metal bent at a right angle.

8. Connecting part according to claim 7, characterized in that on the two edges adjacent the bent edge separating the base (2) from the plate (4), the plate (4) and the base (2) each have a respective rim (34, 32) substantially at a right angle oriented toward the base (2) and the plate (4), respectively, and in that the rims (34) 10 of the plate (4) each have at their end near the base a lug 36) bent so as to be introduced into a corresponding slot (38) formed in a rim (32) of the base (2).

9. Connecting part according to claim 7, characterized in that on the two edges adjacent the bent edge separating the base (2) from the plate (4), the plate (4) and the base (2) each have a respective rim (34, 32) substantially at a right angle oriented toward the base (2) and the plate (4), respectively, and in that the rims (32) of the base (2) each have at their end near the plate (4) a lug bent so as to be introduced into a corresponding slot formed in a rim (34) of the plate (4).

10. Connecting part according to claim 7, characterized in that on each of the two edges adjacent the bent edge separating the base (2) from the plate (4), the plate (4) has a rim (40) substantially at a right angle oriented toward the base (2), in that these two rims (40) of the plate (4) extend beyond the plate (4) in the direction of the base (2) and are bent at a right angle so as to rest against the base (2), and in that the bent portions (42) of the rims (40) each have at least one perforation corresponding to a perforation (6) in the base (2) intended for fixing it.

11. Connecting part according to claim 7, characterized in that it is produced in pregalvanized steel.

12. Set of two connecting parts each including a perforated plate, the two perforated plates being disposed one against the other, characterized in that the two connecting parts are connecting parts according to claim 1.

13. Set of two connecting parts according to claim 12, characterized in that the two connecting parts are identical.

14. Connecting stirrup including a base intended to be fixed to a support and two parallel perforated branches connected by the base, characterized in that each perforated branch takes the form of a plate (4) that includes a first perforation (8) and at least one second perforation (12, 28) taking the form of an oblong hole, possibly curved, the oblong hole (12, 28) being oriented so that its longitudinal axis has, at a given point, a significant inclination relative to the tangent at that point to a circle whose center is a point of the first perforation (8) and that passes through the point concerned 20 of the second perforation (12, 28).

15. Connecting part according to claim 2, characterized in that the second perforation (12, 28) is a rectilinear oblong hole.

16. Connecting part according to claim 2, characterized in that the first perforation (8) is a circular hole adapted to receive a bolt (10, 16) and in that the plate (4) includes two rectilinear oblong holes (12, 28) that are inclined, i.e. whose longitudinal axis (14) does not cross the first perforation (8).

17. Connecting part according to claim 3, characterized in that the first perforation (8) is a circular hole adapted to receive a bolt (10, 16) and in that the plate (4) includes two rectilinear oblong holes (12, 28) that are inclined, i.e. whose longitudinal axis (14) does not cross the first perforation (8).

18. Connecting part according to claim 2, characterized in that the means for fixing it to a support (20) include a base extending in a plane substantially perpendicular to the plate (4).

19. Connecting part according to claim 3, characterized in that the means for fixing it to a support (20) include a base extending in a plane substantially perpendicular to the plate (4).

11. Connecting part according to claim 8, characterized in that it is produced in pregalvanized steel.
